(19) United States
(12) Patent Application Publication
(10) Pub. No.: US 2020/0217765 A1
(43) Pub. Date: Jul. 9, 2020

(54) Mechanical Material Property Test Fixture

(71) Applicants: Michael Fechtmann, Lusby, MD (US); Kyle Archer, Lexington Park, MD (US); Gregg Hurla, Hollywood, MD (US)

(72) Inventors: Michael Fechtmann, Lusby, MD (US); Kyle Archer, Lexington Park, MD (US); Gregg Hurla, Hollywood, MD (US)

(73) Assignee: United States of America as represented by the Secretary of the Navy, Patuxent River, MD (US)

(21) Appl. No.: 16/239,198

(22) Filed: Jan. 3, 2019

(51) Int. Cl. G01N 3/303; G01N 3/04

(52) U.S. Cl. CPC G01N 3/303; G01N 3/04; G01N 2203/001; G01N 2203/025; G01N 2203/0033; G01N 2203/0037; G01N 2203/0254; G01N 2203/0017

(57) ABSTRACT

A mechanical material property test fixture for testing a material, the fixture includes a plurality of beams disposed on one geometrical plane, a plurality of linear bearings, a plurality of hinged linkage bars, and an apparatus that applies force on the plurality of linear bearings such that the material being tested has a uniform force applied on it by the fixture. Each beam has substantially equal angles between adjacent beams, while each linear bearing is disposed on a corresponding beam. The linear bearings are attachable to the material being tested. Each linkage bar communicates with two adjacent linear bearings such that the linear bearings can freely slide along the corresponding beam. The linkage bars are substantially the same length such that a symmetric multi-axial movement in the linear bearings is created, and allows for equal force to be applied to the material.

### STATEMENT OF GOVERNMENT INTEREST

The invention described herein may be manufactured and used by or for the Government of the United States of America for governmental purposes without payment of any royalties thereon or therefor.

### BACKGROUND

There are many methods to take a force vector in one direction as an input and split it into a force in multiple directions, however, most of the mechanisms that do so either have many parts which can make them difficult to manufacture (for example, but without limitation, Hoberman Linkages), the mechanisms rely on rotational components which make implementation unintuitive, they do not provide precise movements, or they do not provide an even and linear splitting of the input force between the output directions.

The majority of these force splitting mechanisms are not planar, as the input force is perpendicular to the output forces, which can limit the miniaturization of the mechanisms and limit the space into which the mechanisms can fit, particularly with regard to converting a uni-axial test frame into a bi-axial and/or multi-axial test frame.

Force splitting can be more easily imagined as a symmetric movement of the end effectors (i.e. grips, probes), so when one end effector is moved, the other end effectors move in tandem, and vice versa, so that the motion of all of the end effectors are constrained to each other. It is the constrained motion that splits the applied force.

A force splitting mechanism can be actuated from one or multiple directions by any force generating entity, whether it is by, but without limitation, human hand, beast of burden, simple machine, falling weight, electric motor, fluid pressure, or combustion engine. Force splitting mechanisms have applications in a wide variety of fields, from mechanical material property test fixtures, to robotic grips, expandable structures and antenna, expanding sails, tooling apparatuses (e.g. framing jigs), apertures, valves, and furniture (e.g. expanding tables), and can be created on vastly different scales from the very small, as in microelectrical mechanical systems (MEMS), to the very large, as in expandable space structures (solar arrays, antennas, and solar sails).

### SUMARY

The present invention is directed to a mechanical material property test fixture for testing a material that includes a plurality of beams disposed on one geometrical plane, each beam having substantially equal angles between adjacent beams; a plurality of linear bearings, each linear bearing disposed on a corresponding beam, the linear bearings attachable to the material; a plurality of hinged linkage bars, each linkage bar communicating with two adjacent linear bearings such that the linear bearings can freely slide along the corresponding beam, the linkage bars are substantially the same length such that a symmetric multi-axial movement in the linear bearings is created, and allows for equal force to be applied to the material; and, an apparatus that applies force on the plurality of linear bearings such that the material being tested has a uniform force applied on it by the fixture.

It is a feature of the present invention to provide a mechanical material property test fixture for testing a material that takes an input force and splits it into multiple components, so that the force is applied along the direction of the input force and some other direction (or directions).

It is a feature of the present invention to provide a mechanical material property test fixture for testing a material that can be used as a bi-axial material mechanical property test fixture either in compression or in tension.

### DRAWINGS

These and other features, aspects, and advantages of the present invention will become better understood with reference to the following description and appended claims, and accompanying drawings wherein:

FIG. 1 is a top perspective view of the test fixture in use with a piece of material under test on a test stand;

FIG. 2 is bottom perspective view of the test fixture in use with a piece of material under test on a test stand; and,

FIG. 3 is a bi-axial embodiment of the test fixture.

### DESCRIPTION

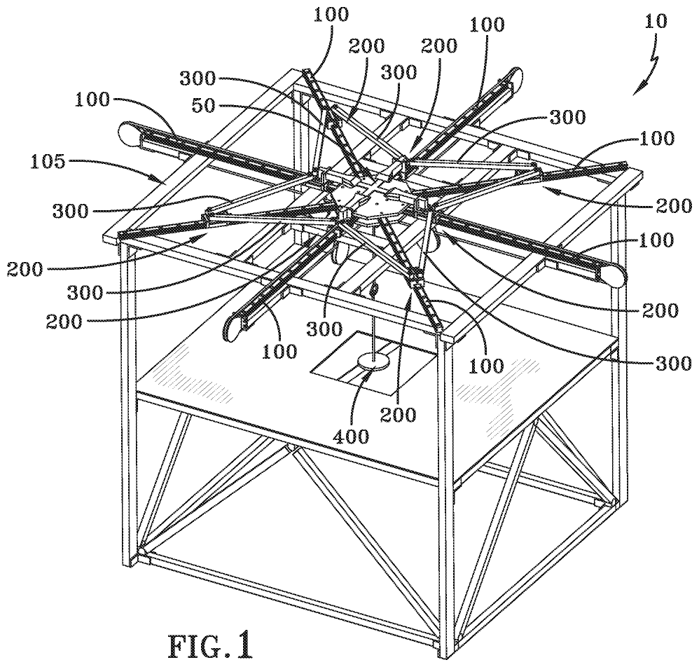

The preferred embodiments of the present invention are illustrated by way of example below and in FIGS. 1-3. As shown in FIG. 1, the mechanical material property test fixture 10 for testing a material 50, the fixture 10 includes a plurality of beams 100 disposed on one geometrical plane 105, a plurality of linear bearings 200, a plurality of hinged linkage bars 300, and an apparatus that applies force 400 on the plurality of linear bearings 200 such that the material 50 being tested has a uniform force applied on it by the fixture 10. Each beam 100 has substantially equal angles between adjacent beams 100, while each linear bearing 200 is disposed on a corresponding beam 100. The linear bearings 200 are attachable to the material 50 being tested. Each linkage bar 300 communicates with two adjacent linear bearings 200 such that the linear bearings 200 can freely slide along the corresponding beam 100. The linkage bars 300 are substantially the same length such that a symmetric multi-axial movement in the linear bearings 200 is created, and allows for equal force to be applied to the material 50. The plurality of beams 100, linear bearings 200, and hinged linkage bars 300 can be collectively referred to a cyclic mechanism.

In the description of the present invention, the invention will be discussed in a military aircraft environment; however, this invention can be utilized for any type of application that requires use of a test fixture.

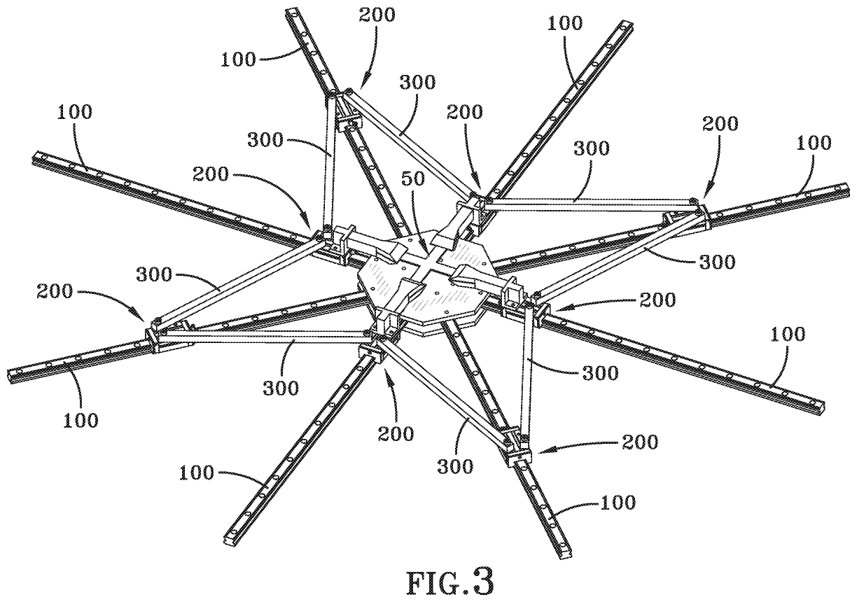

The test fixture 10 is a combination of a variable geometry mechanism (made up of linear bearings 200 and hinged linkage bars 300) that can slide freely on the beams 100 of a fixed geometry frame in a linear fashion. In the preferred embodiment, as shown in FIG. 3, the geometry of the frame is octagonal, with eight beams 100 radiating from the center. The eight beams 100 have substantially equal angles between them, and the linkage bars 300 that connect the linear bearings 200 on adjacent beams are all substantially the same length. This creates a substantially symmetric bi-axial movement in the linear bearings 200, since when one linear bearing 200 slides along a beam 100, each connected linear bearing 200 on the other beams 100 moves in tandem. When the linkage bars 300 are oriented in the shape of a four pointed star, the movement of one linear bearing 200 causes the opposing linear bearing 200 to move in the opposite direction along the same line, while the linear bearings 200 that are perpendicular to the first set of linear bearings 200 also move the opposite direction from each other. The linkage bars 300 can also be arranged so that motion of one linear bearing 200 can cause movement of the opposite linear bearing in the same direction. The length of the linkage bars 300 defines the maximum travel of the linear bearings 200 along the beams 100.

The mechanism of this invention is coupled with grips for holding a material or structure to create a material test fixture. When the mechanism is actuated, the grips pull on the test article along at least two axes. This is particularly useful for testing tensile properties of fabrics, coated fabrics, leather, rubber, and other soft materials, which are often used in inflatable and load bearing applications that produce a bi- or multi-axial strain state in the material. The grips may be replaced with probes to apply compression to a test article, which is useful for cylindrical test articles.

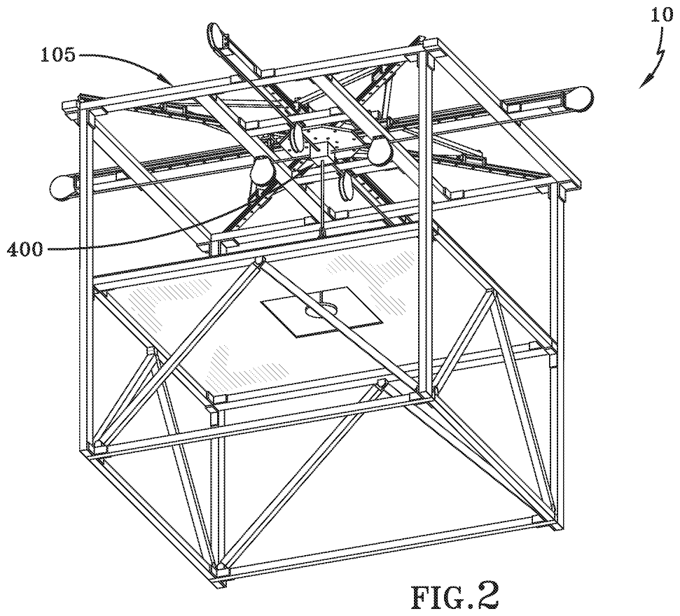

Materials react differently depending on the rate at which a force is applied, so a quasi-static force deforms (or yields) a material in a different manner than a dynamic (i.e. high strain rate) force. For many polymers and metals, a dynamic force will be more likely to cause brittle failure as opposed to ductile yielding. In the preferred embodiment, this bi-axial test fixture applies a force at a high strain rate through the use of a weight that drops and jerks the mechanism apart (generally shown in FIG. 2 by element 400). The force applied can either be in plane with the mechanism perpendicular to the plane of the mechanism, and for the preferred embodiment of the test fixture, the weight is dropped perpendicular to the plane of the mechanism and pulleys and cable are used to transfer the force to move the mechanism. The mechanism was originally designed to test crashworthy fuel bladder materials that are required to endure high dynamic forces; however, it can be utilized for the testing of material for any practicable purpose.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A cyclic mechanism comprising:
a plurality of beams disposed on one geometrical plane, each beam having substantially equal angles between adjacent beams;
a plurality of linear bearings, each linear bearing disposed on a corresponding beam;
a plurality of hinged linkage bars, each linkage bar communicating with two adjacent linear bearings such that the linear bearings can freely slide along the corresponding beam, the linkage bars are substantially the same length such that a symmetric multi-axial movement in the linear bearings is created, and allows for equal force to be applied to the linear bearings.

2. A mechanical material property test fixture for testing a material, the fixture comprising:
a plurality of beams disposed on one geometrical plane, each beam having substantially equal angles between adjacent beams;
a plurality of linear bearings, each linear bearing disposed on a corresponding beam, the linear bearings attachable to the material;
a plurality of hinged linkage bars, each linkage bar communicating with two adjacent linear bearings such that the linear bearings can freely slide along the corresponding beam, the linkage bars are substantially the same length such that a symmetric multi-axial movement in the linear bearings is created, and allows for equal force to be applied to the material; and,
an apparatus that applies force on the plurality of linear bearings such that the material being tested has a uniform force applied on it by the fixture.
